(19) United States
(12) Patent Application Publication
(10) Pub. No.: US 2025/0384227 A1
(43) Pub. Date: Dec. 18, 2025

(54) Computer Automated Neural Architecture Based System And Method For Translation Of Specified Data

(71) Applicant: United We Care Inc, New York, NY (US)

(72) Inventors: SOURAV BANERJEE, Bengaluru (IN); KRISHNAHARA CHAKRAVORTY, Ranchi (IN); AYUSHI AGARWAL, Hyderabad (IN); ANUSH MAHAJAN, Aurangabad (IN)

(73) Assignee: United We Care Inc, New York, NY (US)

(21) Appl. No.: 18/927,834

(22) Filed: Oct. 25, 2024

(30) Foreign Application Priority Data
Oct. 26, 2023 (IN) 202311073041

(51) Int. Cl. G06F 40/58; G06F 40/51; G06N 3/045

(52) U.S. Cl. CPC G06F 40/58; G06F 40/51; G06N 3/045

(57) ABSTRACT

The present invention discloses a method and computer automated system for translation using generative artificial intelligence, wherein the method leverages neural networks, discriminator networks, iterative processing, and feedback mechanisms to generate and optimize translations. By evaluating translation quality and continuously adjusting based on feedback, the system maximizes accuracy and context-specific appropriateness. The neural networks are equipped with advanced features like attention mechanisms and encoder-decoder architectures to capture semantic and syntactic nuances during translation. Furthermore, the approach can personalize translation output, validate translations against reference corpora, adapt to specific industries, and undergo iterative improvements, ultimately enhancing linguistic quality and readability.

### CROSS REFERENCE TO RELATED APPLICATIONS

This application claims priority from Indian Application No. 202311073041 filed Oct. 26, 2023, which is hereby incorporated herein by reference in its entirety.

### BACKGROUND

### Related Art

Language translation is an essential aspect of communication and has undergone significant developments over the years. Conventional techniques for language translation have primarily relied on rule-based approaches, statistical machine translation, and initial neural network models. These methods typically involve translating text from one language to another using predefined linguistic rules or statistical probabilities derived from large bilingual corpora.

In the field of machine translation, the quest for accurate and reliable translations across languages has witnessed significant efforts. Traditional methods, such as statistical models and rule-based systems, have achieved only limited success in
overcoming the complexities of language translation, wherein the rule-based often falls short in capturing the complexity of languages, especially idiomatic expressions and context-specific nuances, resulting in translations that are grammatically accurate but lack fluency and naturalness. While statistical models improved translation quality compared to rule-based systems, it still struggled with capturing the nuances of languages and handling polysemy (words with multiple meanings) effectively In contrast, neural machine translation (NMT) models have shown promise but still face substantial challenges in capturing intricate linguistic patterns and consistently generating high-quality translations.

Conventional arts have concentrated on the development of neural network architectures that learn from extensive bilingual datasets. These datasets often encompass millions of sentence pairs, furnishing the models with a substantial amount of training data. This comprehensive training data empowers the neural networks to gain a deeper understanding of translation patterns present in different languages, thereby enhancing translation accuracy.

Various neural network architectures have been proposed in prior art to elevate translation quality. These architectures frequently employ encoder-decoder frameworks, where an encoder neural network processes the source language input to generate a
hidden representation. The decoder neural network then employs this hidden representation to produce the translated output. Additionally, attention mechanisms, recurrent neural networks (RNNs), and convolutional neural networks (CNNs) have been integrated into these architectures to further enhance translation performance.

Despite these advancements, certain challenges persist in the realm of reliable machine translation. Handling rare or out-of-vocabulary (OOV) words is one such challenge. Machine translation models struggle to effectively translate words or phrases with infrequent occurrences in their training data. This limitation directly impacts the overall quality of translations, compromising the system's reliability.

Context awareness in translation is another formidable challenge. The meaning and translation of a word or phrase is often contingent on the surrounding words or phrases, necessitating an understanding of contextual cues. While prior art has explored attention mechanisms to address this issue, there is still room for further advancements in achieving robust and context-aware translations.

Machine translation's reliability is further threatened by adversarial attacks, where adversaries intentionally introduce perturbations or modifications to the source text to manipulate the translation model into generating incorrect or misleading translations. These attacks exploit vulnerabilities in the model's training and inference processes, undermining its reliability and trustworthiness.

Initial neural network-based translation models faced challenges related to data scarcity and limitations in neural network architectures, impacting their translation accuracy and fluency. These models lacked the ability to adapt dynamically to the specific characteristics of input data. Given these challenges, there is a pressing need for a novel neural network architecture that can effectively handle rare words, incorporate context-awareness for accurate translations, and defend against adversarial attacks. Such an architecture should ensure the production of trustworthy and high-quality translations across different languages, thereby addressing the existing limitations and challenges in the field of reliable machine translation.

On a different front, the World Health Organization (WHO) has developed a highly accurate manual translation protocol that has demonstrated its effectiveness over time. This protocol ensures reliable translations of documents through a meticulous process, although it has not yet incorporated advancements in data science research for quantitative evaluation. Nevertheless, the established methodology by WHO remains a trustworthy and precise approach for manual translation. The WHO protocol utilizes a bilingual panel comprising individuals skilled in interviewing and assessment, clinicians, and potentially behavioral scientists or anthropologists. This diverse group collaboratively reviews translations to identify and rectify any inconsistencies or issues that may arise. Their collective expertise helps maintain the integrity of the source instrument, ensuring conceptual, semantic, and technical equivalence.

Monolingual individuals representing the target culture and potential users of the translated document play a crucial role. They provide valuable feedback to ensure that the translation accurately captures cultural nuances, idiomatic expressions, and context-specific elements relevant to the target audience. Their insights contribute to refining the translation, making it culturally sensitive and easily understandable.

The methodology also involves at least two translators with proficiency in both languages and a deep understanding of the subject matter. They are responsible for the initial translation from the source language to the local language. An independent back translator, not involved in the initial translation, adds an extra layer of quality control. This back translator faithfully renders the translated document back into the original language, allowing for the identification of any significant differences or potential errors. By combining the expertise of the bilingual panel, the insights of monolingual individuals, and the skills of the translators, this manual translation protocol offers a comprehensive and reliable approach. The collaborative nature of the process, coupled with multiple checks and balances, ensures that the translated documents are accurate, culturally appropriate, and maintain the intended meaning and integrity of the source instrument. Although the protocol has not yet incorporated quantitative evaluation using data science research, its longstanding track record of success demonstrates its reliability in producing high-quality translations for various studies and applications.

The combination of the WHO Manual Protocol and modern data science techniques holds promise in enhancing the translation model. The WHO Manual Protocol provides essential guidelines and standards for translation in the healthcare domain, ensuring accuracy and consistency. On the other hand, modern data science techniques, such as neural machine translation (NMT), leverage advanced algorithms to improve translation quality and enable accurate quantification.

Hence, there exists a need for a method, architecture, and system for language translation that bridges the gap between the innovations in data science and the established manual translation protocols. Such a solution should harness the power of neural network architectures, leveraging the advances in NMT and data-driven approaches to enhance translation quality while also integrating the meticulous and time-tested practices of human translators and language experts. By combining the strengths of both approaches, it becomes possible to create a translation model that not only achieves remarkable accuracy but also maintains the cultural and contextual nuances that are often lost in automated translations. The development of this integrated solution represents a significant leap forward in the field of language translation, promising a new era of reliable, context-aware, and culturally sensitive translations.

Therefore, there is a need for a new translation system that overcomes the limitations of conventional methods, wherein the new system described in the present invention leverages generative artificial intelligence and neural networks to provide highly accurate and contextually appropriate translations and also focuses on adaptability, context preservation, and robustness, thereby addressing the shortcomings of the rule-based and early machine translation systems.

### OBJECTS OF THE INVENTION

The present invention introduces a method for language translation, specifically designed to address the limitations of conventional systems. It harnesses the power of generative artificial intelligence, utilizing two neural networks (NN1 and NN2), and introduces an iterative translation process with a feedback loop, resulting in highly accurate, contextually appropriate translations. The primary objective of this invention is to provide a comprehensive solution to the longstanding challenges of language translation by enhancing adaptability, context preservation, and translation quality.

The other objective of this invention is to revolutionize the field of language translation by developing a system that adapts to various languages, domains, and contexts, thereby offering accurate and contextually appropriate translations. This dynamic approach eliminates the need for costly manual intervention and resolves issues associated with conventional translation methods. By optimizing the cost functions of the neural networks based on feedback from discriminator networks, the invention continuously enhances translation quality, convergence speed, and linguistic accuracy.

It is an object of the present invention to provide a novel neural network architecture for language translation that effectively addresses the challenges of rare and out-of-vocabulary words. By incorporating innovative mechanisms, the invention aims to improve the translation of infrequently occurring words, thereby enhancing the overall translation quality and ensuring reliable communication across languages.

It is an object of the present invention to introduce an architecture that prioritizes context-awareness in language translation. The invention seeks to develop a translation model that considers the surrounding words and phrases, leading to more accurate and contextually appropriate translations. By doing so, it aims to significantly reduce translation errors and better capture the intended meaning of the source text.

It is an object of the present invention to bolster the resilience of machine translation systems against adversarial attacks. The invention strives to develop mechanisms that can detect and mitigate manipulations in the source text, ensuring the reliability and trustworthiness of the translation. By enhancing the security of translation models, it contributes to safeguarding the integrity of communication in sensitive and critical domains.

It is an object of the present invention to capture Language-specific nuances, idiomatic expressions, and cultural factors in order to enhance the fluency and naturalness of translations.

It is an object of the present invention to evaluate translation quality, with DN1 assessing the initial translation and providing feedback. DN2 assesses the translation back to the source language, facilitating the iterative process and optimizing the translation.

It is an object of the present invention to dynamically adapt based on user feedback, preferences, or specific translation requirements, personalizing the translation output.

It is an object of the present invention to integrate the strengths of modern data science techniques with the well-established WHO Manual Translation Protocol. The invention seeks to create a harmonious blend of automated translation algorithms and human expertise, allowing for highly accurate and culturally sensitive translations. By combining these approaches, it aims to provide a comprehensive solution for producing high-quality translations across various domains and applications.

It is an object of the present invention to establish a methodology that maintains the advantages of both automated and manual translation processes. The invention aims to streamline the translation process by automating the initial steps while retaining human intervention for context-specific and culturally nuanced elements. This approach ensures the reliability and precision of translations while benefiting from the efficiency and speed of automated systems, making it a versatile solution for diverse translation needs.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer implemented generative artificial intelligence based method for translation, comprising generating translated text from a first language to a second language using a first neural network (nn1) based on input data (i1). The computer implemented generative artificial intelligence based method also includes evaluating a quality of the translation in the second language (o1), said evaluating may include measuring the discrepancy between the translated output (o1) and a target language, where the target language is the second language. The method also includes based on the measured discrepancy between the translated output (o1) and the target language, adjusting the translation based on the measured discrepancy. According to an embodiment of the method, the adjusting may include, via a first discriminator network (dn1), at least one of accepting the translation and rejecting the translation. Based on a rejected translation, the method comprises generating an alternate translation (o11). According to a preferred embodiment, the method includes evaluating a quality of the generated alternate translation and may include comparing the generated alternate translation with input data via the first discriminator network (dn1) associated with the first neural network (nn1). Additionally, the method includes sending the accepted translation or the generated alternate translation to a second discriminator network (dn2) associated with a second neural network (nn2). According to an embodiment, the method includes translating the accepted translation or the generated translation back to the first language (o2) by the second neural network (nn2). The translation back to the first language (o2) is compared with the original input first language (i1) by the second discriminator network (dn2), where the comparing may include calculating the cosine similarity between o2 and i1, resulting in the value o2. The method also includes evaluating the quality of the translation output (o1) which evaluating may include measuring the discrepancy between the translated output and the target language. Preferably, a self-learning step comprises optimizing the first and second neural networks (nn1 and nn2) based on the second discriminator network's (dn2) evaluation provided as feedback in a return path to the cost functions of the first and second discriminator networks (nn1 and nn2) respectively. Other embodiments of this aspect include corresponding computer systems, apparatus, and computer programs recorded on one or more computer storage devices, each configured to perform the actions of the methods.

One general aspect includes a computer automated system comprising a processing unit coupled to a memory element and having instructions encoded thereon, which instructions cause the computer automated system to: via a generative artificial intelligence module: generate translated text from a first language to a second language using a first neural network (nn1) based on input data (i1). The computer automated system is further configured to evaluate a quality of the translation in the second language (o1), which evaluating may include measuring the discrepancy between the translated output (o1) and a target language, where the target language is the second language. Based on the measured discrepancy between the translated output (o1) and the target language, the computer automated system is configured to adjust the translation based on the measured discrepancy. According to an embodiment, the adjusting may include, via a first discriminator network (dn1), at least one of accepting the translation and rejecting the translation. Based on a rejected translation, the computer automated system is configured to generate an alternate translation (o11), and preferably to evaluate a quality of the generated alternate translation, which evaluating may include comparing the generated alternate translation with input data via the first discriminator network (dn1) associated with the first neural network (nn1). According to an embodiment, the accepted translation or the generated alternate translation is sent to a second discriminator network (dn2) associated with a second neural network (nn2), wherein the second neural network (nn2) is caused to translate the accepted translation or the generated translation back to the first language (o2). The translation back to the first language (o2) is compared with the original input first language (i1) by the second discriminator network (dn2), where the comparison may include calculating the cosine similarity between o2 and i1, resulting in the value o21. The computer automated system is preferably configured to evaluate the quality of the translation output (o1) which evaluation may include measuring the discrepancy between the translated output and the target language.

Preferably, the computer automated system is configured to self-learn and thereby optimize the first and second neural networks (nn1 and nn2) based on the second discriminator network's (dn2) evaluation provided as feedback in a return path to the cost functions of the first and second discriminator networks (nn1 and nn2) respectively. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates a schematic diagram of a neural network for iterative translation and training with Limited Data implemented by means of a neural network architecture.

FIGS. 2A and 2B illustrate method steps for iterative translation and training implemented by means of a neural network architecture.

FIG. 3 illustrates an example of a system implementation of a neural network architecture for iterative translation and training.

### DETAILED DESCRIPTION

Generic Language Model (LLM) translation models, although widely used, have certain limitations that hinder their translation accuracy and quality. These limitations arise from the fact that generic LLMs are not specifically fine-tuned for each input and lack the ability to iteratively improve translations.

Firstly, generic LLM translation models often struggle with producing accurate translations for specific inputs. Due to their generic nature, they are not tailored to handle the nuances, context, and domain-specific vocabulary of individual inputs. As a result, the translations may contain errors, inaccuracies, or lack contextual appropriateness, compromising the overall translation quality.

Secondly, generic LLM models may not effectively address rare words or phrases that are not commonly encountered in the training data. Translating such rare words accurately becomes a challenge as the model may not have sufficient exposure to them during training. Consequently, the translations of these words may be inadequate 35 or incorrect.

Additionally, generic LLM translation models typically rely on fixed model parameters and do not undergo significant changes during the translation process. This lack of adaptability limits their ability to refine translations based on specific inputs or improve the overall translation quality over time.

The limitations of generic LLM translation models highlight the need for an alternative approach that specifically addresses these shortcomings. The proposed model, which incorporates iterative fine-tuning based on each input, addresses these limitations, and offers several advantages.

By iteratively processing identical text inputs, the model aims to achieve accurate translations with minimal deviation from the original input. This iterative approach allows the system to continuously refine and improve the translations, resulting in higher accuracy and quality. The fine-tuning process enables the model to adapt to the specific nuances, vocabulary, and context of each input, ensuring contextually appropriate translations. Furthermore, the constrained information-sharing scheme in the proposed model prevents the occurrence of Nash equilibrium. This scheme promotes continuous improvement in translation accuracy and eliminates stagnation, enhancing the overall effectiveness of the translation process.

Basic structure of the Proposed Model: The proposed model introduces a neural network architecture that leverages two neural networks (NN1 and NN2) and two discriminator networks (DN1 and DN2). According to an embodiment, NN1 focuses on generating translations and considers factors such as Translation Quality, Language Diversity, and Cost Function Update. According to a preferred embodiment, DN1 evaluates the output of NN1, ensuring the desired language's dominance in the translation.

According to an embodiment, NN2 facilitates back translation, enhancing bidirectional translation capabilities. Additionally, DN2 evaluates the quality of the back translation using diverse metrics. The feedback loop involving DN2 guides the learning and optimization processes of both NN1 and NN2, leading to continuous improvement in translation quality. According to a preferred embodiment, word embeddings and positional vectors are shared among the neural networks, ensuring consistency throughout the translation process. DN2's positional vector serves as a unifying factor, contributing to comprehensive and effective translation.

The embodiments disclosed address the limitations of generic LLM translation models and offer a more tailored and refined approach to translation. Iterative fine-tuning, constrained information-sharing scheme, and feedback mechanisms contribute to improved accuracy, contextual appropriateness, and overall translation quality.

Embodiments disclosed include a method that utilizes neural networks and various factors to achieve perfect translation, even when limited data is available. According to an embodiment, the method leverages a neural architecture containing two translation neural models, NN1 and NN2, and two discriminator models DN1 and DN2. The positional embedding of DN2 is shared between all the networks.

The present invention deals with language translation, offering a robust and adaptable solution that overcomes the limitations of conventional translation systems. At its core, the invention harnesses the capabilities of generative artificial intelligence, driven by two interconnected neural networks, NN1 and NN2. Unlike traditional translation models that focus primarily on optimizing fixed model parameters, the present invention takes an innovative approach, enabling iterative processing of text inputs for optimized translations and ensures that the translation output remains reliable and contextually appropriate, a stark departure from the traditional static methods that struggle with contextual nuances.

The system incorporates several key components; Neural Networks (NN1 and NN2), equipped with advanced attention mechanisms, encoder-decoder architectures, and contextual understanding to capture and preserve the underlying semantic and syntactic information during translation. Discriminator Networks (DN1 and DN2) evaluate translation quality, with DN1 scrutinizing the initial translation and providing valuable feedback. DN2 further assesses the translation back to the source language, enabling an iterative and optimized translation process. Validation modules cross-reference translations with known accurate translations and reference corpora to ensure their reliability, and iterative processing continually enhances translation quality through gradient-based updates.

Input Data: This module receives the text in the first language (Language 1) that needs to be translated into the second language (Language 2). It serves as the starting point for the translation process, providing the raw data for subsequent processing.

First Neural Network (NN1): NN1 is the core component responsible for generating translated text from Language 1 to Language 2. It employs sophisticated artificial intelligence techniques, including attention mechanisms, encoder-decoder architectures, and contextual understanding to ensure accurate and contextually appropriate translations.

Translation Quality Evaluation Module (O1): O1 evaluates the quality of the translation generated by NN1. It measures the discrepancy between the translated output and the target language, which is Language 2. This evaluation is crucial for ensuring translation accuracy.

First Discriminator Network (DN1): DN1 plays a pivotal role in the adjustment of translations. It assesses the quality of the translation generated by NN1 and decides whether to accept or reject it based on predefined evaluation criteria.

Alternate Translation Generation Module (O11): In the event of a rejected translation, this module generates an alternate translation (O11) that meets the predefined evaluation criteria. It acts as a fallback mechanism to ensure quality translation output.

Second Neural Network (NN2): NN2 handles the back translation process, translating the accepted translation or the generated alternate translation from Language 2 back to Language 1. This bidirectional translation enhances overall quality and alignment with the original input.

Back Translation Quality Evaluation Module (O2): O2 evaluates the quality of the back translation generated by NN2. It ensures that the back translation accurately reflects the original input in Language 1.

Second Discriminator Network (DN2): DN2, associated with NN2, performs a comprehensive evaluation of the back translation. It calculates the cosine similarity and other vector and text comparison metrics between the back translation (O2) and the original input (I1).

Feedback and Optimization Module: The feedback from DN2's evaluation is integrated into this module to optimize the first and second neural networks (NN1 and NN2). It involves fine-tuning model parameters, updating the cost functions of both DN1 and DN2, and iteratively enhancing the translation process to ensure high-quality and contextually appropriate translations. This module is vital for continuous improvement in translation quality.

The present system is designed to adapt dynamically, ensuring accurate and contextually appropriate translations without the need for extensive manual intervention.

The inventive approach resolves longstanding issues associated with conventional translation methods, providing a dynamic and adaptable system that improves translation quality over time. By optimizing the cost functions of the neural networks based on feedback from discriminator networks, embodiments disclosed demonstrate the remarkable ability to continuously refine translations, enhance linguistic accuracy, and achieve faster convergence. The introduction of adaptability, validation modules, post-processing techniques, and integration options enables a cutting-edge solution capable of transcending language barriers and revolutionizing the translation landscape across various industries and domains.

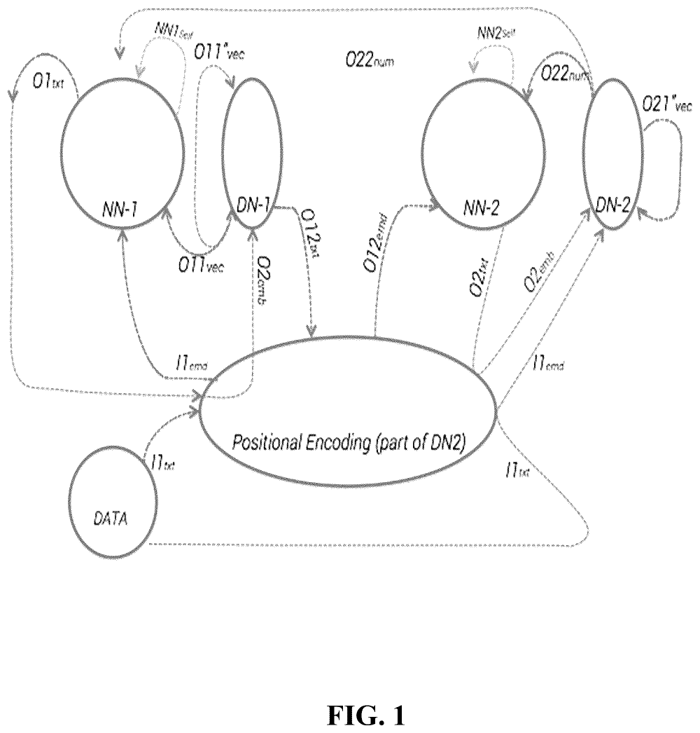

FIG. 1A illustrates a method for Reliable Machine Translation by means of an innovative Neural Network Architecture with Limited Data. This figure illustrates the proposed method for addressing challenges in machine translation with limited data. The architecture consists of three main components: a neural network (NN1) for translation generation, a discriminator network (DN1) for evaluation, and a second neural network (NN2) for back translation. The architecture incorporates three key factors in the cost function of NN1: Translation Quality, Language Diversity, and Cost Function Update.

The generated translation from NN1 is evaluated by DN1, which assesses the percentage of words in the desired language. If the output is complete in the desired language, it proceeds to NN2 for back translation, enhancing bidirectional translation. The quality of the back translation is evaluated by another discriminator network (DN2) using various vector comparison and text comparison metrics.

According to an embodiment, feedback from DN2 guides the learning and optimization processes of both NN1 and NN2, leading to continuous improvement in translation quality. The neural networks share word embeddings and positional vectors, ensuring consistency throughout the translation process. The positional vector of DN2 is used across all neural networks, facilitating comprehensive and effective translation.

This neural network architecture effectively addresses challenges related to handling rare words, context-awareness, and adversarial attacks, enabling the production of trustworthy and high-quality translations with limited data. Experimental evaluation and comparative analysis demonstrate the effectiveness of the proposed architecture, highlighting its potential for improving machine translation in real-world scenarios.

Description of the cost functions: The process begins with a neural network, NN1, which generates translations from one language (Language 1) to another (Language 2) based on input data. The cost function of NN1 combines three key factors to evaluate and optimize the quality of the translation.

Translation Quality: This factor aims to minimize discrepancies between the generated translation and the target language, ensuring a close alignment with the desired output. It focuses on improving the accuracy and fidelity of the translation, striving for high-quality language conversion.

Language Diversity: When the initial translation is rejected by DN1, this factor becomes significant. It utilizes the output vector O11vec from DN2, which indicates the percentage of words in different languages. By considering the percentage of words that do not match the desired language (100%—O11vec), it introduces an alternative translation approach. This factor encourages NN1 to produce more words in Language 2, promoting language diversity and enhancing the overall translation capability.

Input-specific Update: This factor enables NN1 to recalibrate the translation output by incorporating an additional value derived from cosine similarity or similar vectors obtained from DN2. This value provides information on the overall efficiency of the translation system. By integrating this update into the cost function, NN1 can optimize its performance by considering the similarity between the back translation and the original input, leading to improved translation accuracy and effectiveness.

These three factors collectively contribute to evaluating and optimizing the quality of the translation generated by NN1. They address the aspects of translation accuracy, language diversity, and system efficiency, ensuring that the resulting translations closely align with the desired target language and meet the highest quality standards.

The generated translation from NN1 i.e. O1 is evaluated by a discriminator network, DN1, by comparing the O1 with words of different languages. It gives an output vector O11vec. Herein the vector gives a score on a language-wise % reporting the % of output words, in each of the languages of consideration. If the O11 is 100% i.e. all words are in Language 2, then it allows the O1 to be transferred to NN2 as O22. And if O11 is not 100%. Then it sends back the difference between 100 and the obtained value of O11 as to the cost function of NN1. And NN1 is reoperated, and its output is fed to DN1 to produce O11 vex. This process continues until either O11=100% is achieved or no further increment is achieved over n-iterations. The objective of the discriminator thus is to only let information pass when either O1 is complete with the desired language or NN1 can't further improve.

The learning objective of DN1 is to grow its vocabulary and identify more words for which translation in the desired language couldn't be found.

Herein one factor of the cost function includes training DN1 on label data of different languages and then checking whether the output vector predicts the language accurately or not. So if training is done on language n, then the cost function will be 100−(O11-Language N).

The other part of the DN1 is to grow its vocabulary. So when marginal return is achieved during back and forth between NN1 and DN1. And DN1 has to approve a text without achieving O11=100. Then the same difference (100−O11) will act as a factor for the cost function for DN1. Thus encouraging DN1 to grow its horizon and take new words in its fold.

If the translation is approved, it proceeds to a second neural network, NN2, for back translation from Language 2 to Language 1, enhancing bidirectional translation and overall quality.

The quality of the back translation is evaluated by a second discriminator network, DN2, which calculates the cosine similarity between the back translation and the original input. The specific details of DN2's cost function are derived by a combination of vector comparison metrics and text comparison matrix. Vector comparison matrix can be included. cosine similarity, Moving vector distance, Euclidean space, Manhattan space. Text comparison matrices can include the Jaccard index, hamming index, etc.

Feedback based on DN2's evaluation is then provided to the cost functions of both NN1 and NN2, guiding their learning and optimization process. This feedback loop continuously improves the translation quality, ensuring better alignment with the original input.

It's worth noting that the neural networks involved in the method share the same word embedding and positional vector, ensuring consistency throughout the translation process. Additionally, the positional vector of DN2 is used across all neural networks, facilitating a comprehensive and effective translation.

The stop function of the model is attained when marginal return in the DN2's cost function is obtained i.e. cost function of DN2 shows no further improvement on continued iteration.

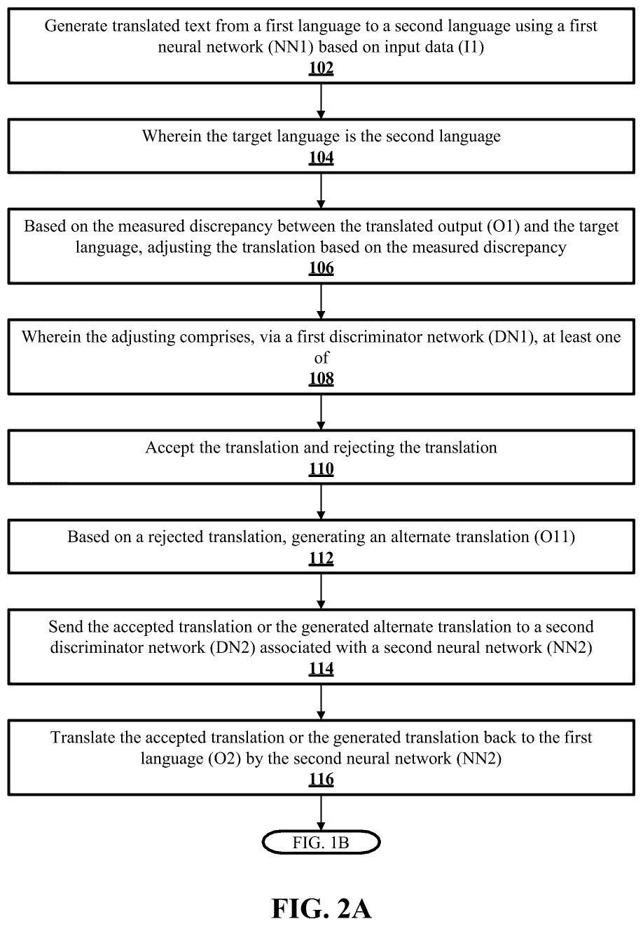

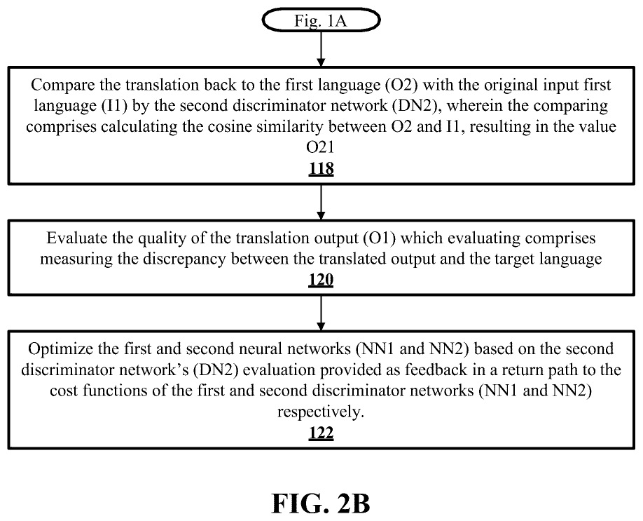

Workflow of the model—FIG. 2 200 illustrates a flowchart of the method according to an embodiment. The flowchart illustrates the step-by-step process involved in the inventive solution for generating translations from one language to another while optimizing the translation quality. The process incorporates the use of neural networks, cost functions, and discriminator networks to enhance the accuracy and effectiveness of the translation process.

In step 202, the initial phase involves Neural Network 1 (NN1) generates translations from Language 1 to Language 2 based on input data (I1). Step 204 involves evaluating the quality of the translation generated by NN1. Step 206 entails sending the translation to NN2 if the quality of the translation meets the evaluation criteria. Alternatively, if the quality of the translation does not meet the evaluation criteria, step 206 entails sending the translation to NN1 to generate an alternate translation (step 208) that meets the evaluation criteria. Subsequently, in step 210, the alternate generated translation is sent to NN2 for back translation to language 1. Step 212 entails back translating the accepted translation or the alternate generated translation. Again, in step 214 the quality of the back translation is evaluated using DN2. Step 216 includes providing feedback from DN2's evaluation to the cost functions of both NN1 and NN2. Step 218 includes performing a check for a return in DN2's cost function. If DN2's cost function shows no further improvement on continued iteration, the process is stopped in step 220.

According to a preferred embodiment, step 202 further comprises evaluating Translation Quality by comparing the generated translation with the target language. Preferably the method includes calculating Language Diversity by analyzing the output vector O11vec from Discriminator Network 1 (DN1). O11vec represents the percentage of words in different languages. According to an embodiment, alternative translations from different languages are incorporated into NN1's cost function, encouraging more words in Language 2. The cost function is preferably updating the cost by incorporating feedback value derived from cosine similarity (output from DN2).

According to a preferred embodiment, step 204 further comprises comparing O1 with words in different languages by DN1. An embodiment includes calculating the output vector O11vec, which provides language-wise percentages of output words. According to an example embodiment, if O11vec is 100%, transfer O1 to Neural Network 2 (NN2) as O22. And if O11vec is not 100%, send the difference between 100 and O11vec back to NN1's cost function. The aforementioned steps are repeated until O11vec=100% or no improvement is achieved over n iterations.

It should be noted that the learning objective of DN1 is to grow vocabulary by identifying words for which translation in the desired language couldn't be found. An additional objective according to an embodiment, is to train DN1 on labeled data of different languages to predict the language accurately. Preferably, DN1's cost function is adjusted based on the difference between 100 and O11vec to encourage vocabulary growth. Thus, if translation is approved, proceed to Neural Network 2 (NN2) for back translation from Language 2 to Language 1, i.e. Step 206.

After step 212, step 214 further comprises evaluating the quality of the back translation using Discriminator Network 2 (DN2), wherein DN2 calculates cosine similarity and other vector and text comparison metrics between the back translation and the original input. Subsequent step 216 further comprises providing e feedback from DN2's evaluation to the cost functions of both NN1 and NN2. According to an embodiment, the computer implemented method is configured to guide the learning and optimization process of NN1 and NN2, in order to continuously improve the translation quality and alignment with the original input.

Preferred embodiments of the computer implemented method ensure consistency throughout the translation process. Preferably, neural networks share the same word embedding and positional vector, and DN2's positional vector is used across all neural networks.

Finally, step 218 implements a check for a marginal return in DN2's cost function. And if DN2's cost function shows no further improvement on continued iteration, the process is ended (step 220).

In another embodiment, the method starts with receiving the input text (I1) which is in a first Language 1. This input text is required to be translated into a target Language 2. The input text is received by the first neural network 1 (NN1) which may be trained on a language model. NN1 generates an initial translation (O1) from Language 1 to Language 2 based on the input text (I1).

At the next step, discriminator network (DN1) receives the initial translation (O1) and evaluates initial translation (O1) by comparing it with words in different languages, checking for a match with Language 2. Discriminator network (DN1) calculates an output vector O11vec, which provides language-wise percentages of output words. The initial translation (O1) is evaluated by discriminator network (DN1) for Translation Quality, Language Diversity, and Input-specific Update. Discriminator network (DN1) calculates Translation Quality to minimize discrepancies between initial translation (O1) and the target language (Language 2). The Discriminator network (DN1) checks for Language Diversity using the output vector O11vec and adjusts the cost function of NN1 to encourage language diversity. At each iteration a new translation (O1) is created.

In an aspect, if O11vec is 100%, the initial translation (O1) is sent for back-translation. Else if O11vec is not 100%, then the difference between 100 and O11vec-is sent back to NN1's cost function. This step is repeated until O11vec=100% or no improvement is observed over a specified number of iterations (n).

Further, using the iterative updated translations DN1 aims to grow its vocabulary and improve language prediction accuracy. DN1 is trained on labeled data of different languages to predict language accurately. Moreover, DN1's cost function is adjusted based on the difference between 100 and O11vec to encourage vocabulary growth.

Once the translation from NN1 is approved by DN1, Neural Network 2 (NN2) is provided with translation for back translation from Language 2 to Language 1, enhancing bidirectional translation and overall quality. Neural Network 2 (NN2) generates a back-translation from Language 2 to Language1 which is evaluated by Discriminator network (DN2).

Discriminator network (DN2) evaluates the quality of the back translation by calculating cosine similarity and other vector and text comparison metrics between the back translation and the original input. The evaluation results from DN2 are provided to update the cost functions of both NN1 and NN2.

It is ensured that the neural networks involved share the same word embedding and positional vector, maintaining consistency throughout the translation process. The positional vector of DN2 is used across all neural networks to facilitate comprehensive and effective translation.

The cost function of Discriminator network (DN2) is continuously monitored for improvement. In case DN2's cost function shows no further improvement on continued iteration, the translation process is stopped. The translation process ends when the stop function is triggered, ensuring that the translation has reached its maximum quality.

These method steps outline the process of the proposed invention, emphasizing iterative translation, feedback loops, and information sharing to achieve highly accurate and contextually appropriate translations.

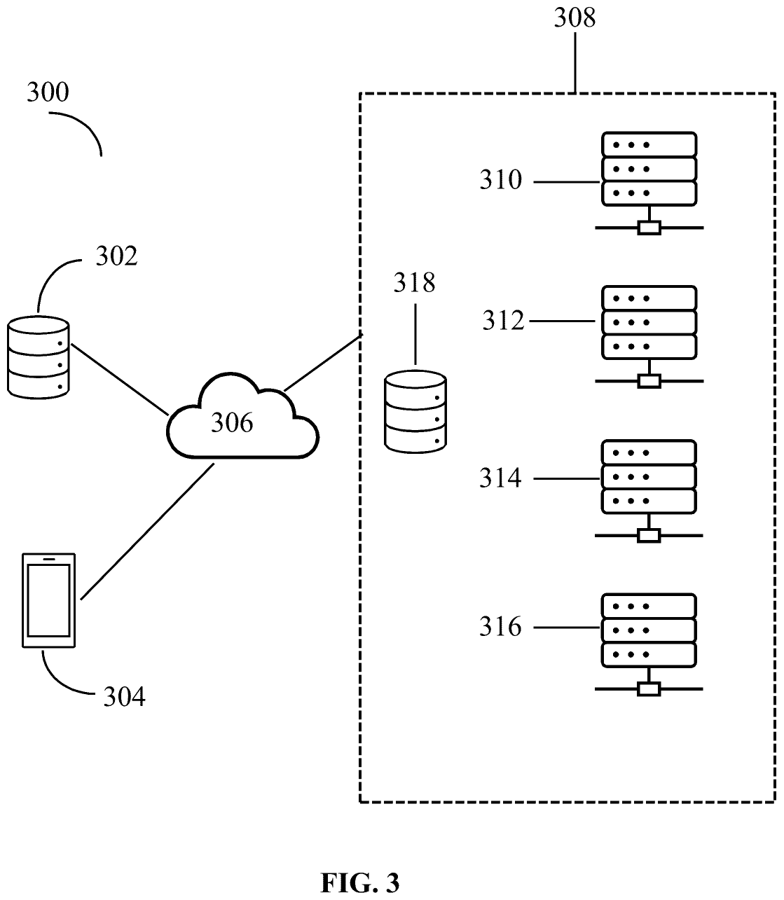

FIG. 3 illustrates an example of a system implementation of a neural network architecture for iterative translation and training. The system 300 provides a user with a device 304 for providing input data (I1) that is communicated to a neural network architecture 308 via a network 306. Alternatively, pre-stored input data stored in a database 302 may be shared via network 306 to the neural architecture 308. The input data may be shared with the neural network architecture 308 via any other means without deviating from the inventive concept of the method as described above.

The neural architecture 308 may be implemented as a distributed system having one or more databases 318 and one or more computational means such as server 310 (NN1), server 312 (DN1), server 314 (NN2), and server 316 (DN2).

In an embodiment, Neural Network 1 (NN1) implemented by server 310 receives the input data (I1) via network element 306, the input data (I1) is in the first language (Language 1) and needs to be translated into second language (Language 2). Ther server 310 upon receiving the input data (I1) generates the translation (O1).

The generated translation (O1) from Server 1 is then verified by the server 312 which implements discriminator network 1 (DN1). Server 312 evaluates the quality of the translation received from server 310 by comparing the generated translation with the target language (Language 2). Server 312 generates O11vec giving a score on a language-wise % reporting the % of output words, in each of the languages of consideration. DN1 calculates the Language Diversity by analysing the output vector O11vec. Server 312 iteratively evaluates the output produced by NN1 till either the O11vec becomes 100% or no further incremental changes are observed.

Server 310 implementing NN1 considering the cost function factors especially translation quality, language diversity, and input-specific update among others. Server 310 while implementing the translation quality factor of NN1 aims to minimize discrepancies between the generated translation and the target language thereby ensuring a close alignment with the desired output.

In an aspect, one of the factors of the cost function includes training DN1 on label data of different languages and then checking whether the output vector predicts the language accurately or not. Further, the other part of the DN1 is to grow its vocabulary. So, when marginal return is achieved during back and forth between NN1 and DN1, and DN1 has to approve a text without achieving O11=100, then the same difference (100−O11) will act as a factor for the cost function for DN1.

The server 312 implementing the discriminator network 1 (DN1) iteratively compares the output received from Server 310 with words in different languages. These words may be stored in database 318 which is communicatively coupled with the server 312 and is readily accessible. The server 312 based on the comparison of the output received from server 310 calculates the O11vec which identifies the similarities or dissimilarities between the iterative output of server 310 and the desired output based on the sample data available to server 312. The sample data or model data may also be stored in database 318, the sample data may also be updated based on the O11vec generated upon each translation iteration.

The O11vec calculated by server 312 indicates the percentage of words that do not match the desired language. This encourages NN1 to produce more words in Language 2, promoting language diversity and enhancing the overall translation capability.

The server 312 may transmit the translated data (O1) to server 314 for back-translation once the O11vec is 100% or else may iteratively send the difference between 100 and O11vec back to the cost function of NN1.

In an aspect, server 312 is enabled to grow vocabulary by identifying words for which translation in the desired language couldn't be found.

In another aspect, server 312 enables training DN1 on labelled data of different languages to predict the language accurately.

In another aspect, the server 312 may enable adjusting DN1's cost function based on the difference between 100 and O11vec to encourage vocabulary growth.

The server 314 implementing the neural network 2 takes the O1 translated data from NN1 and thereafter back translated data from Language 2 to Language 1. The corresponding discriminator network 2 (DN2) is implemented by server 316 that verifies the back-translation received from server 314. DN2 executed by server 316 calculates cosine similarity and other vector and text comparison metrics between the back translation and the original input.

Server 316 provides feedback from discriminator network 2 (DN2) to the cost functions of both NN1 on server 310 and NN2 on server 314. Server 316 guides the learning and optimization process of NN1 and NN2 and continuously improves the translation quality and alignment with the original input. The back translation from server 314 is evaluated in view of the input data (I1).

In an embodiment, both the server 310 (NN1) and server 314 (NN2) share the same positional vector generated by server 316 (DN2) thereby ensuring consistency. If DN2 does not show improvement on iterative translation, then the output O11 is accepted as the final translation.

In one aspect, the architecture described in FIG. 1 and FIG. 3 enables iterative processing of identical text inputs, aiming to achieve a translated output that on the reverse translation by server 314 either exactly matches the input or exhibits minimal textual deviation. This ensures that the system can handle a wide range of input variations.

In another aspect, the system described in FIG. 2 employs a constrained information-sharing scheme at each iteration to prevent the occurrence of the Nash equilibrium. This scheme controls the information exchange between the neural networks (both NN1 and NN2), ensuring that the system does not reach a stable state without further improvement. By avoiding suboptimal translation outputs, the architecture continuously refines the translation over multiple iterations, leading to more accurate and contextually appropriate translations.

In yet another aspect, feedback mechanisms have been devised to provide valuable insights into the system's performance and guide the iterative improvement process. By incorporating real-world data, the system can adapt and learn from actual translation examples, further enhancing the accuracy and reliability of the translations.

The system as described in FIG. 3 ensures symmetrical information exchange among the neural networks and maintains consistent vectorization procedures. Server 16 implementing DN2 provides the positional vector exclusively responsible for positional vectorization, ensuring that the translation process captures the necessary positional information for accurate translations. This symmetrical information exchange and consistent vectorization contribute to the overall reliability and authenticity of the translation process.

In an aspect, the neural architecture of FIG. 1 and FIG. 3 considers the final output of the network as an intermediate value rather than the system's ultimate output. This unique perspective allows for the derivation of the actual usable objective, such as translation to Language2, from this intermediate value. By treating the output as an intermediate step, subsequent iterations on the same data can further refine the translation and improve its accuracy.

The architecture 308 allows iterative processing of each text input to achieve optimized translations The architecture 308 focuses on continuously improving the translation output for each specific input. During the iterative process, the text flows through the model multiple times until no further improvement in the translation is observed. By dynamically adjusting the model parameters during the iterations, the architecture can adapt to the specific characteristics of the input data, resulting in reliable and contextually appropriate translations.

Embodiments disclosed enable iterative processing of identical text inputs, achieving a translated output that on the reverse translation either exactly matches the input or exhibits minimal textual deviation. This iterative approach sets it apart from traditional translation models, as it allows for continuous improvement in translation accuracy and ensures that the system can handle a wide range of input variations.

Embodiments disclosed include systems and methods that employ a constrained information-sharing scheme at each iteration to prevent the occurrence of Nash equilibrium. This scheme controls the information exchange between the neural networks, ensuring that the system does not reach a stable state without further improvement. By avoiding suboptimal translation outputs, the architecture continuously refines the translation over multiple iterations, leading to more accurate and contextually appropriate translations.

Embodiments disclosed include systems and methods comprising feedback mechanisms devised to diligently monitor and discriminate the system's behavior at each step, leveraging empirical data. These mechanisms provide valuable insights into the system's performance and guide the iterative improvement process. By incorporating real-world data, the system can adapt and learn from actual translation examples, further enhancing the accuracy and reliability of the translations.

Embodiments disclosed include an architecture that ensures symmetrical information exchange among the neural networks and maintains consistent vectorization procedures. DN2's positional vector is exclusively responsible for positional vectorization, ensuring that the translation process captures the necessary positional information for accurate translations. This symmetrical information exchange and consistent vectorization contribute to the overall reliability and authenticity of the translation process.

Additional embodiments of the systems and methods disclosed include architecture that considers the final output of the network as an intermediate value rather than the system's ultimate output. This unique perspective allows for the derivation of the actual usable objective, such as translation to Language2, from this intermediate value. By treating the output as an intermediate step, subsequent iterations on the same data can further refine the translation and improve its accuracy.

Embodiments disclosed enable models to undergo minor parameter changes during iterations, resulting in unique parameter configurations for each input data. Despite these dynamic parameter changes, the translation output remains highly reliable, showcasing the robustness and adaptability of the architecture. This is a radical departure from the conventional focus on optimizing model parameters in most Language-Modelling Models (LLMs) or translation models.

The architecture of embodiments disclosed takes a unique approach by allowing iterative processing of each text input to achieve optimized translations. Unlike traditional translation models, where a pre-trained model is used to obtain translations, this architecture focuses on continuously improving the translation output for each specific input. During the iterative process, the text flows through the model multiple times until no further improvement in the translation is observed. This prioritizes the output over the model properties, ensuring that the translation accuracy is maximized for each input text. By dynamically adjusting the model parameters during the iterations, the architecture can adapt to the specific characteristics of the input data, resulting in reliable and contextually appropriate translations.

This iterative approach offers significant utility in providing text-specific translations that are highly accurate and tailored to the nuances of the input text. It allows for continuous refinement and improvement, ensuring that the translation output meets the highest standards of quality and reliability. The overall system is designed to ensure that the model parameters and observation metrics cannot falsely claim reliable translation success, adding a layer of authenticity to the translation process. By incorporating iterative processing, constrained information-sharing, feedback mechanisms, symmetrical information exchange, and a unique perspective on model parameters, this innovation addresses the need for accurate and contextually appropriate translations, making it a much-needed advancement in the field of language translation. Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus, it will be understood by those skilled in the art of computer automated artificial intelligence-based systems and methods, and more particularly computer automated generative artificial intelligence based translation systems and methods, that although the preferred and alternate embodiments have been shown and described in accordance with the Patent Statutes, the invention is not limited thereto or thereby.

The figures illustrate the architecture, functionality, and operation of possible implementations of systems, methods, and computer program products according to various embodiments of the present invention. It should also be noted that, in some alternative implementations, the functions noted/illustrated may occur out of the order noted in the figures. For example, two blocks shown in succession may, in fact, be executed concurrently, or the blocks may sometimes be executed in the reverse order, depending upon the functionality involved.

The terminology used herein is for the purpose of describing embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any program nomenclature that follows is used merely for convenience, and thus the invention should not be limited to use solely in any specific application identified and/or implied by such nomenclature.

The present invention and some of its advantages have been described in detail for some embodiments. It should be understood that although the system and process are described with reference to computer automated artificial intelligence based translation systems and methods, the system and method is highly reconfigurable, and may be used in other systems as well. Portions of the embodiment may be used to support artificial intelligence-based applications completely unrelated to translation. Modifications of the embodiments may be used to machine-to-machine interactions that could potentially replace human intervention. It should also be understood that various changes, substitutions, and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the embodiments of the process, machine, manufacture, composition of matter, means, methods and steps described in the specification. A person having ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

1. A computer implemented generative artificial intelligence based method for translation, comprising:
generating translated text from a first language to a second language using a first neural network (NN1) based on input data (I1);
evaluating quality of the translation in the second language (O1), said evaluating comprising measuring the discrepancy between the translated output (O1) and a target language;
wherein the target language is the second language;
based on the measured discrepancy between the translated output (O1) and the target language, adjusting the translation based on the measured discrepancy;
wherein the adjusting comprises, via a first discriminator network (DN1), at least one of: accepting the translation or rejecting the translation;
based on a rejected translation, generating an alternate translation (O11);
evaluating a quality of the generated alternate translation, comprising comparing the generated alternate translation with input data via the first discriminator network (DN1) associated with the first neural network (NN1);
sending the accepted translation or the generated alternate translation to a second discriminator network (DN2) associated with a second neural network (NN2);
translating the accepted translation or the generated translation back to the first language (O2) by the second neural network (NN2);
comparing the translation back to the first language (O2) with the original input first language (I1) by the second discriminator network (DN2), wherein the comparing comprises calculating the cosine similarity between O2 and I1, resulting in the value O21;
evaluating the quality of the translation output (O1) which evaluating comprises measuring the discrepancy between the translated output and the target language; and
optimizing the first and second neural networks (NN1 and NN2) based on the second discriminator network's (DN2) evaluation provided as feedback in a return path to the cost functions of the first and second discriminator networks (NN1 and NN2) respectively.

2. The computer implemented generative artificial intelligence based method of claim 1 further comprising, based on the rejected translation, and generated alternate translation, evaluating the quality of the generated translation, which evaluating comprises comparing the generated translation with original input data via the first discriminator network; and
wherein the comparing comprises assessing the discrepancy between O11ij and O11ij(j−1) wherein i is the ith input and j is the jth iteration for the ith input.

3. The computer implemented generative artificial intelligence based method of claim 1, wherein the first and second neural networks (NN1 and NN2) comprise at least one of a single or plurality of attention mechanisms, encoder-decoder architectures, and contextual understanding to capture and preserve the semantic and syntactic information during translation.

4. The computer implemented generative artificial intelligence based method of claim 1, further comprising validating the first and second translations (O1 and O2) using verification modules configured to compare the translated text against at least one of known accurate translations and reference corpora.

5. The computer implemented generative artificial intelligence based method of claim 1 further comprising adjusting the model parameters to optimize the translation output in retranslation.

6. The computer implemented generative artificial intelligence based method of claim I 30 wherein feedback from the second discriminator network is used to update the model parameters and optimize the translation process.

7. The computer implemented generative artificial intelligence based method of claim 1 wherein the first and second translations arc validated using metrics, wherein the metrics comprise BLEU score and METEOR score.

8. The computer implemented generative artificial intelligence based method of claim 1 wherein the first and second neural networks (NN1 and NN2) are trained on large datasets of bilingual text pairs to enable accurate translation.

9. The computer implemented generative artificial intelligence based method of claim 1 wherein the first neural network (NN1) employs pre-training and fine-tuning techniques using large-scale monolingual corpora to improve the translation performance.

10. The computer implemented generative artificial intelligence based method of claim 1 wherein the first discriminator network (DN1) uses a combination of supervised and unsupervised learning approaches to evaluate the quality of the first generated translation (O1) accurately.

11. The computer implemented generative artificial intelligence based method of claim 1 further comprising capturing language-specific nuances and expressions by the second neural network to enhance the consistency and fluency of the first and second translations.

12. The computer implemented generative artificial intelligence based method of claim 1 further comprising optimizing the translations for specific fields or industries by incorporating domain-specific knowledge or specialized translation models into the first and second neural networks (NN1 and NN2).

13. The computer implemented generative artificial intelligence based method of claim 1 further comprising iteratively enhancing the translation performance, wherein the feedback provided to the cost functions of both NN1 and NN2 comprises gradient-based updates, weight adjustments, or learning rate modifications to iteratively.

14. The computer implemented generative artificial intelligence based method of claim 1 further comprising improving the accuracy and convergence speed of the first and second translation, wherein the improving comprises optimizing the cost functions of NN1 and NN2 using optimization algorithms comprising stochastic gradient descent (SGD), Adam, and RMS prop.

15. The computer implemented generative artificial intelligence based method of claim 1, wherein the translation models comprised in the first and second neural networks (NN1 and NN2) are dynamically adapted based on user feedback, user preferences, or specific translation requirements to personalize the translation output.

16. The computer implemented generative artificial intelligence based method of claim 1, wherein the first and second translations (O1 and O2) undergo post-processing techniques comprising tokenization, detokenization, normalization, and smoothing to refine the linguistic quality and readability of the translated text.

17. The computer implemented generative artificial intelligence-based method of claim 1, further comprising means for integration with a plurality of software applications and platforms, said means comprising user interface or an application programming interface (API).

18-34. (canceled)

35. The computer implemented generative artificial intelligence based method of claim 1, wherein the first neural network (NN1) and the second neural network (NN2) share word embeddings and positional vectors.

36. The computer implemented generative artificial intelligence based method of claim 1, wherein DN1 is trained on labelled data of different languages.

37. The computer implemented generative artificial intelligence based method of claim 1, wherein the DN2 generates a positional vector shared by NN1 and NN2.
